(19) United States
(12) Patent Application Publication
(10) Pub. No.: US 2026/0172145 A1
(43) Pub. Date: Jun. 18, 2026

(54) POLAR HYBRID AUTOMATIC REPEAT REQUEST

(71) Applicant: QUALCOMM Incorporated, San Diego, CA (US)

(72) Inventors: Wei YANG, San Diego, CA (US); Kirill IVANOV, La Jolla, CA (US)

(21) Appl. No.: 18/978,607

(22) Filed: Dec. 12, 2024

(51) Int. Cl. H04L 1/00; H04L 1/1812

(52) U.S. Cl. CPC H04L 1/0057; H04L 1/1812

(57) ABSTRACT

Various aspects of the present disclosure generally relate to wireless communication. In some aspects, a wireless communication device may transmit, via a first transmission of a hybrid automatic repeat request (HARQ) procedure, a first set of information bits, wherein the first set of information bits are encoded into a first polar codeword of a first size. The wireless communication device may transmit, via a second transmission of the HARQ procedure, the first set of information bits and a second set of information bits, wherein the first set of information bits and the second set of information bits are jointly encoded into a second polar codeword of a second size. Numerous other aspects are described.

### FIELD OF THE DISCLOSURE

Aspects of the present disclosure generally relate to wireless communication and specifically relate to techniques, apparatuses, and methods associated with a polar hybrid automatic repeat request.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Incremental redundancy HARQ (IR-HARQ) is a HARQ technique in which multiple sets of coded bits may be generated, each representing the same set of information bits. In this case, a retransmission may use a different set of coded bits from a previous transmission, with different redundancy versions (RVs) generated by puncturing the encoder output. In this way, IR-HARQ may provide robustness against inaccurate rate control, bursty interference, fading channels, or other issues that may reduce reliability of a data channel in addition to improving coverage and spectral efficiency. For example, a receiver (e.g., a UE) may support IR-HARQ by performing rate matching of low density parity check (LDPC) codes using a circular buffer that may be filled with an ordered sequence of systematic bits and parity bits.

In some cases, a wireless communication network may use polar codes to implement channel coding for downlink and/or uplink control channel communications. Polar coding is a linear block coding technique that is based on the phenomenon of channel polarization. Polar coding has provable capacity-achieving performance over binary channels with polynomial complexity in various scenarios (such as channel coding, among others).

### SUMMARY

Hybrid automatic repeat request (HARQ) includes a combination of high-rate forward error correction (FEC) and automatic repeat request (ARQ) error-control. In ARQ, a transmitter may add redundant bits to a message to be transmitted using an error-detecting code, such as a cyclic redundancy check (CRC), and a receiver that fails to correctly decode the message (e.g., based on the CRC) may request a retransmission of the message from the transmitter. In some cases, the message may be transmitted with repetitions to enable the receiver to perform soft combining to combine the information in the initial transmission of the message with information from the message in the repeated transmissions of the message in an attempt to decode the combined information.

Various aspects relate generally to a polar HARQ process that enables a transmitting device to add new information to a retransmission of a communication. Some aspects more specifically relate to adding new information bits to a second transmission of a HARQ procedure. In some aspects, a first set of information bits may be transmitted in a first transmission of a HARQ procedure and the first set of information bits and a set of one or more new or additional information bits may be transmitted in a second transmission of the HARQ procedure. In some aspects, the first set of information and the additional information bits may be jointly encoded in a second polar code word.

Some aspects described herein relate to a method of wireless communication performed by a wireless communication device. The method may include transmitting, via a first transmission of a HARQ procedure, a first set of information bits, wherein the first set of information bits are encoded into a first polar codeword of a first size. The method may include transmitting, via a second transmission of the HARQ procedure, the first set of information bits and a second set of information bits, wherein the first set of information bits and the second set of information bits are jointly encoded into a second polar codeword of a second size.

Some aspects described herein relate to a method of wireless communication performed by a wireless communication device. The method may include receiving, via a first transmission of a HARQ procedure, a first set of information bits, wherein the first set of information bits are encoded into a first polar codeword of a first size. The method may include receiving, via a second transmission of the HARQ procedure, the first set of information bits and a second set of information bits, wherein the first set of information bits and the second set of information bits are jointly encoded into a second polar codeword of a second size.

Some aspects described herein relate to a non-transitory computer-readable medium that stores a set of instructions for wireless communication by a wireless communication device. The set of instructions, when executed by one or more processors of the wireless communication device, may cause the wireless communication device to transmit, via a first transmission of a HARQ procedure, a first set of information bits, wherein the first set of information bits are encoded into a first polar codeword of a first size. The set of instructions, when executed by one or more processors of the wireless communication device, may cause the wireless communication device to transmit, via a second transmission of the HARQ procedure, the first set of information bits and a second set of information bits, wherein the first set of information bits and the second set of information bits are jointly encoded into a second polar codeword of a second size.

Some aspects described herein relate to a non-transitory computer-readable medium that stores a set of instructions for wireless communication by a wireless communication device. The set of instructions, when executed by one or more processors of the wireless communication device, may cause the wireless communication device to receive, via a first transmission of a HARQ procedure, a first set of information bits, wherein the first set of information bits are encoded into a first polar codeword of a first size. The set of instructions, when executed by one or more processors of the wireless communication device, may cause the wireless communication device to receive, via a second transmission of the HARQ procedure, the first set of information bits and a second set of information bits, wherein the first set of information bits and the second set of information bits are jointly encoded into a second polar codeword of a second size.

Some aspects described herein relate to a wireless communication device for wireless communication. The wireless communication device may include one or more memories and one or more processors coupled to the one or more memories. The one or more processors may be configured to transmit, via a first transmission of a HARQ procedure, a first set of information bits, wherein the first set of information bits are encoded into a first polar codeword of a first size. The one or more processors may be configured to transmit, via a second transmission of the HARQ procedure, the first set of information bits and a second set of information bits, wherein the first set of information bits and the second set of information bits are jointly encoded into a second polar codeword of a second size.

Some aspects described herein relate to a wireless communication device for wireless communication. The wireless communication device may include one or more memories and one or more processors coupled to the one or more memories. The one or more processors may be configured to receive, via a first transmission of a HARQ procedure, a first set of information bits, wherein the first set of information bits are encoded into a first polar codeword of a first size. The one or more processors may be configured to receive, via a second transmission of the HARQ procedure, the first set of information bits and a second set of information bits, wherein the first set of information bits and the second set of information bits are jointly encoded into a second polar codeword of a second size.

Some aspects described herein relate to an apparatus for wireless communication. The apparatus may include means for transmitting, via a first transmission of a HARQ procedure, a first set of information bits, wherein the first set of information bits are encoded into a first polar codeword of a first size. The apparatus may include means for transmitting, via a second transmission of the HARQ procedure, the first set of information bits and a second set of information bits, wherein the first set of information bits and the second set of information bits are jointly encoded into a second polar codeword of a second size.

Some aspects described herein relate to an apparatus for wireless communication. The apparatus may include means for receiving, via a first transmission of a HARQ procedure, a first set of information bits, wherein the first set of information bits are encoded into a first polar codeword of a first size. The apparatus may include means for receiving, via a second transmission of the HARQ procedure, the first set of information bits and a second set of information bits, wherein the first set of information bits and the second set of information bits are jointly encoded into a second polar codeword of a second size.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a polar coding operation, in accordance with the present disclosure.

FIG. 4 is a diagram illustrating an example of polar coding copy-based hybrid automatic repeat request (HARQ) procedure, in accordance with the present disclosure.

FIGS. 5 and 6A-6C are diagrams illustrating examples associated with polar HARQ, in accordance with the present disclosure.

FIG. 7 is a diagram illustrating an example process performed, for example, at a wireless communication device or an apparatus of a wireless communication device, in accordance with the present disclosure.

FIG. 8 is a diagram illustrating an example process performed, for example, at a wireless communication device or an apparatus of a wireless communication device, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Hybrid automatic repeat request (HARQ) includes a combination of high-rate forward error correction (FEC) and automatic repeat request (ARQ) error-control. In ARQ, a transmitter may add redundant bits to a message to be transmitted using an error-detecting code, such as a cyclic redundancy check (CRC), and a receiver that fails to correctly decode the message (e.g., based on the CRC) may request a retransmission of the message from the transmitter. In HARQ, the original data may be encoded with an FEC code, and parity bits may be sent along with the message or transmitted upon request from the receiver in connection with the receiver detecting a failure to correctly decode the message. In HARQ, when a receiver (e.g., a user equipment (UE)) receives a transmission (e.g., a physical downlink shared channel (PDSCH) transmission) that carries a transport block (TB) and the receiver is unable to correctly decode the TB, the receiver may store information from the incorrectly decoded TB in a HARQ buffer.

In some cases, when the receiver subsequently receives a retransmission of the TB (e.g., after requesting the retransmission by transmitting a negative acknowledgement (NACK) in a HARQ acknowledgement (HARQ-ACK) feedback occasion), the receiver may perform soft combining to combine the information stored in the HARQ buffer with information from the retransmitted TB in an attempt to decode the combined information. For example, the receiver may use log-likelihood ratio (LLR) soft combining to combine multiple transmissions of a message. In this case, the receiver may store, in the HARQ buffer, LLR values for the demodulator output for a transmission of a message (e.g., a respective LLR value for each bit in the received message), and may then combine the stored LLR values with LLR values for the demodulator output for a retransmission of the message prior to decoding the combined LLR values.

Incremental redundancy HARQ (IR-HARQ) is a HARQ technique in which multiple sets of coded bits may be generated, each representing the same set of information bits. In this case, a retransmission may use a different set of coded bits from a previous transmission, with different redundancy versions (RVs) generated by puncturing the encoder output. In this way, IR-HARQ may provide robustness against inaccurate rate control, bursty interference, fading channels, or other issues that may reduce reliability of a data channel in addition to improving coverage and spectral efficiency. For example, a receiver (e.g., a UE) may support IR-HARQ by performing rate matching of low density parity check (LDPC) codes using a circular buffer that may be filled with an ordered sequence of systematic bits and parity bits.

In some cases, a wireless communication network may use polar codes to implement channel coding for downlink and/or uplink control channel communications. Polar coding is a linear block coding technique that is based on the phenomenon of channel polarization. Polar coding has provable capacity-achieving performance over binary channels with polynomial complexity in various scenarios (such as channel coding, among others).

Polar coding has a built-in channel polarization structure that uses a recursive construction to split (or “polarize”) a communication channel into reliable subchannels that are very good for transmitting information and unreliable subchannels that are very bad for transmitting information. The reliable subchannels may be almost completely noiseless, with a capacity that approaches 1, and the unreliable subchannels may be almost completely noisy, with a capacity that approaches 0. During polar encoding, a polar transform is applied to assign information bits to the reliable subchannels and to assign “frozen” or “fixed” bits (for example, “0” bits) to the unreliable subchannels.

In some cases, to support IR-HARQ, polar encoding may utilize a copy-based IR-HARQ. A copy-based IR-HARQ operation may include encoding information bits using a polar code to generate a codeword of a first size for a transmission and transmitting some portion of a codeword generated from the information bits using a polar code of a second (e.g., larger) size for a retransmission. The likelihood of decoding information bits encoded with a larger polar code (e.g., size 2N) may be greater than the likelihood of decoding information encoded with a smaller polar code (e.g., size N).

In one example, a transmitting device encodes information bits for a receiving device using a first polar code of a first size (e.g., size N), yielding a first set of encoded bits. To provide coding gain, the number of encoded bits is greater than the number of information bits. The first set of encoded bits may be understood as a first codeword. The transmitting device may transmit the first set of encoded bits to the receiving device. In some cases, the receiving device receives the first set of encoded bits but fails to successfully decode the first codeword. In such cases, the transmitting device may determine that the decoding was unsuccessful (e.g., based on receiving an indication from the receiving device or failing to receive any response from the receiving device) and may prepare a retransmission to the receiving device.

When preparing the retransmission, the transmitting device may generate a second set of encoded bits using a second polar code of the first size (e.g., size N) and the first set of encoded bits. In some cases, the transmitting device may assign known (or “frozen”) bits to the polarized bit channels of the second polar code and may perform an exclusive OR (XOR) operation on the first set of encoded bits and the output of the second polar code. By using logic 0's as the frozen bits, the output of the XOR operation may result in the same bit values as the first set of encoded bits. Thus, the bit values used for the second set of encoded bits may be the same as the first set of encoded bits.

In some cases, the first and second sets of encoded bits together may be considered as making up a second codeword. Although the first and second sets of encoded bits may be generated using polar codes of a first size (e.g., size N), the second codeword including the first and second sets of encoded bits may have a larger effective size (e.g., size 2N).

After generating the second set of encoded bits, the transmitting device may transmit the second set of encoded bits to the receiving device. The receiving device may receive the second set of encoded bits and decode the second codeword using both the received first set of encoded bits and the received second set of encoded bits. As discussed above, the likelihood of decoding information bits encoded using a larger polar code may be higher than if the information bits were encoded using a smaller polar code, which may enable the receiving device to successfully decode the second codeword.

In some cases, the transmitting device may want to add some new information to the retransmission. For example, the transmitting device may have urgent/high priority information to be transmitted to the receiving device and/or the retransmission does not utilize all of the resources available to the transmitting device for transmitting information to the receiving device. As another example, a transmission of uplink control information may collide with a retransmission of another uplink control information transmission. However, existing methods for implementing polar coding and IR-HARQ may not support the addition of new information to a retransmission of a communication.

Various aspects relate generally to a polar HARQ process that enables a transmitting device to add new information to a retransmission of a communication. Some aspects more specifically relate to adding new information bits to a second transmission of a HARQ procedure. In some aspects, a first set of information bits may be transmitted in a first transmission of a HARQ procedure and the first set of information bits and a set of one or more new or additional information bits may be transmitted in a second transmission of the HARQ procedure. In some aspects, the first set of information and the additional information bits may be jointly encoded in a second polar code word.

Particular aspects of the subject matter described in this disclosure can be implemented to realize one or more of the following potential advantages. In some examples, the described techniques can be used to enable additional information to be polar encoded and included in a subsequent transmission of a HARQ procedure.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

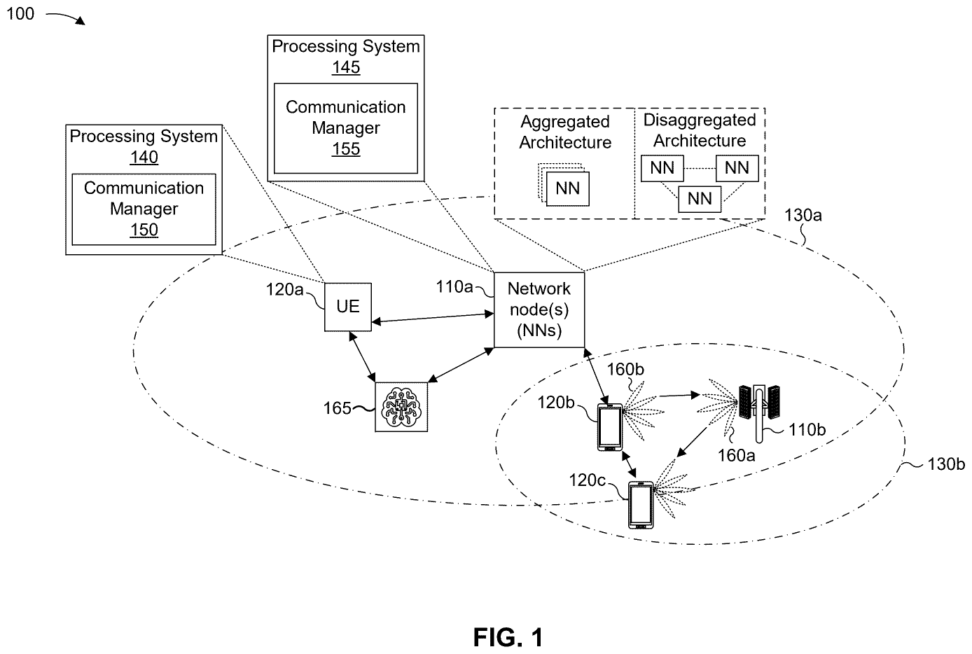

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

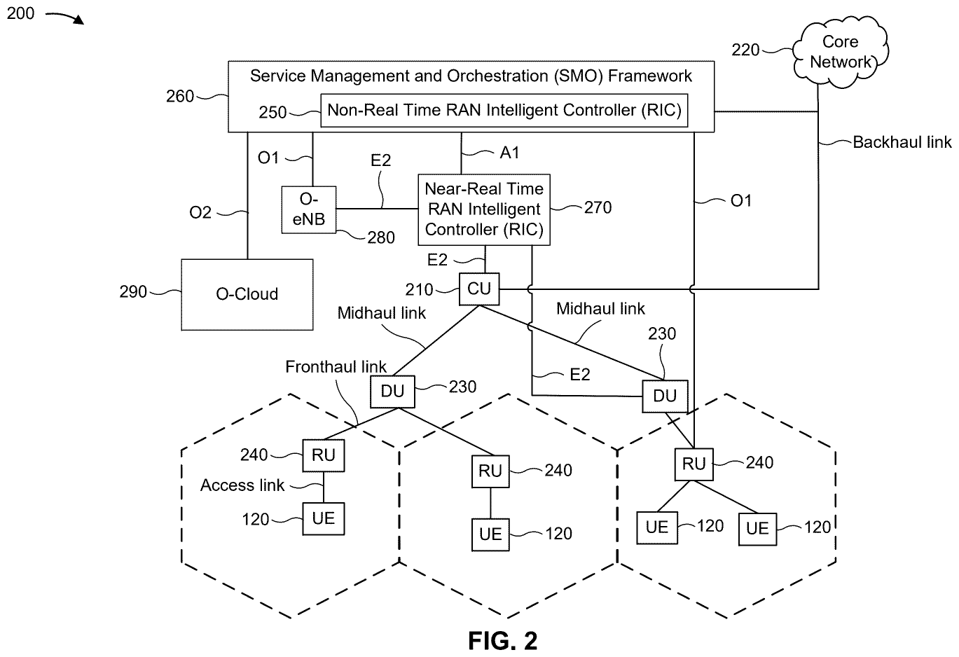

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code).

In the wireless communication network 100, information may be represented as a sequence of binary bits that are mapped (for example, modulated) to an analog signal waveform that is transmitted to a receiver over a wireless communication channel. In some cases, however, the wireless communication channel may introduce errors that corrupt the transmitted signal due to random noise, interference, device impairments, and/or other factors. At the receiver, the received signal (that may have been corrupted during transmission) is mapped back to binary bits, with the received binary information estimating the transmitted binary information. Accordingly, because errors may corrupt the signal that is estimated at the receiver, channel coding or FEC techniques are often used to control errors in data transmission over unreliable or noisy communication channels or otherwise mitigate the bit errors that may occur due to noise, interference, and/or other factors. For example, channel coding generally includes an encoding operation performed at a transmitter (for example, a first wireless communication device, which may be a UE 120 or a network node 110) and a decoding operation performed at a receiver (for example, a second wireless communication device, which may be a UE 120 or a network node 110). As discussed above, channel coding is generally accomplished by selectively introducing redundancy into the transmitted information stream, typically using an ECC, which allows the receiver to detect errors and/or correct bit errors in the received data stream and thereby provide more reliable information transmission. Accordingly, channel codes are often used in scenarios where retransmissions are undesirable and/or high transmission reliability is needed, such as downlink and/or uplink control channel communications.

For example, in some cases, the wireless communication network 100 may use polar codes to implement channel coding for downlink and/or uplink control channel communications. More particularly, polar coding is a linear block coding technique that has provable capacity-achieving performance over binary channels with polynomial complexity in various scenarios (such as channel coding, among others). Polar coding has a built-in channel polarization structure that uses a recursive construction to split (or “polarize”) a communication channel into reliable subchannels that are very good for transmitting information and unreliable subchannels that are very bad for transmitting information. The reliable subchannels may be almost completely noiseless, with a capacity that approaches 1, and the unreliable subchannels may be almost completely noisy, with a capacity that approaches 0. During polar encoding, a polar transform is applied to assign information bits to the reliable subchannels and to assign “frozen” or “fixed” bits (for example, “0” bits) to the unreliable subchannels. For example, a polar code with a rate R=K/N may be defined according to a set of parameters {N, K, G_{N}, A}, where N is a code block length with N=2ⁿ, for n≥1, K is a code dimension, A is a data index set, A⊂{1, 2, . . . , N} with size |A|=K, and G_{N} is a polar transform defined by:

$${G}_{2} = [ \begin{matrix}1 & 0 \\ 1 & 1\end{matrix} ] , {G}_{N} = [ \begin{matrix}{G}_{N / 2} & 0 \\ {G}_{N / 2} & {G}_{N / 2}\end{matrix} ] = {G}_{2}^{⊗ n}$$

Given a data block d=(d₁, . . . , d_{K}), a polar code with the parameters {N, K, G_{N}, A} encodes the data block d in two steps, where the first step is to construct a transform input block u=(u₁, . . . , u_{N}) by setting:

$${u}_{A} {=}^{△} ( {u}_{i} : i ∈ A ) = d , {u}_{{A}^{C}} {=}^{△} ( {u}_{i} : i ∈ {A}^{C} ) = 0$$

and the second step is to compute the code block x by computing the polar transform of u, where x=uG_{N}. Accordingly, polar codes have an encoding/decoding complexity given by N log N, a construction complexity that is roughly O(N), and a block error probability that approaches zero roughly as 2^{-\sqrt{N}} for any fixed rate R that is less than a channel capacity (for example, there is no error floor).

The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, wireless communication device (e.g., a network node 110 or a UE 120) may include a communication manager 150 or a communication manager 155. As described in more detail elsewhere herein, the communication manager 150, 155 may transmit, via a first transmission of a HARQ procedure, a first set of information bits, wherein the first set of information bits are encoded into a first polar codeword of a first size; and transmit, via a second transmission of the HARQ procedure, the first set of information bits and a second set of information bits, wherein the first set of information bits and the second set of information bits are jointly encoded into a second polar codeword of a second size. Additionally, or alternatively, the communication manager 150, 155 may perform one or more other operations described herein.

In some aspects, a wireless communication device (e.g., a network node 110 or a UE 120) may include a communication manager 150 or a communication manager 155. As described in more detail elsewhere herein, the communication manager 150, 155 may receive, via a first transmission of a HARQ procedure, a first set of information bits, wherein the first set of information bits are encoded into a first polar codeword of a first size; and receive, via a second transmission of the HARQ procedure, the first set of information bits and a second set of information bits, wherein the first set of information bits and the second set of information bits are jointly encoded into a second polar codeword of a second size. Additionally, or alternatively, the communication manager 150, 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

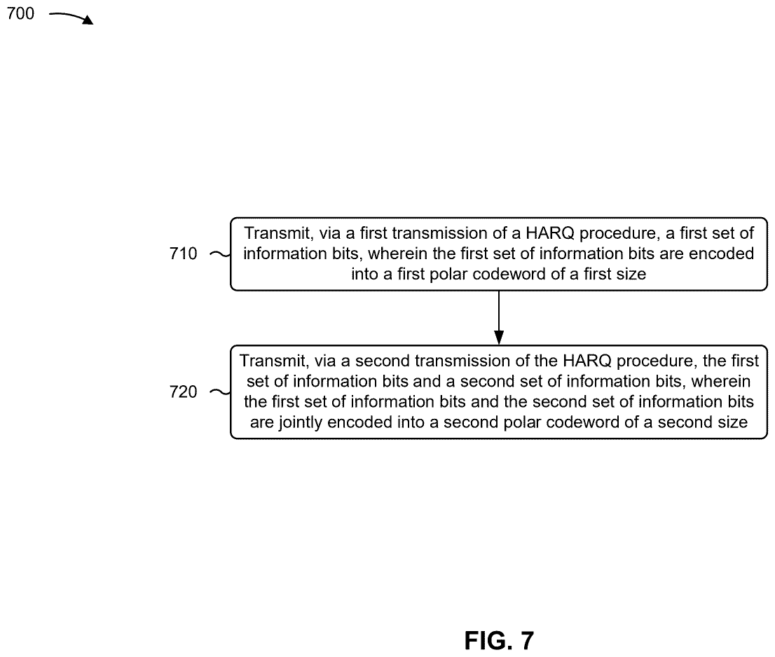

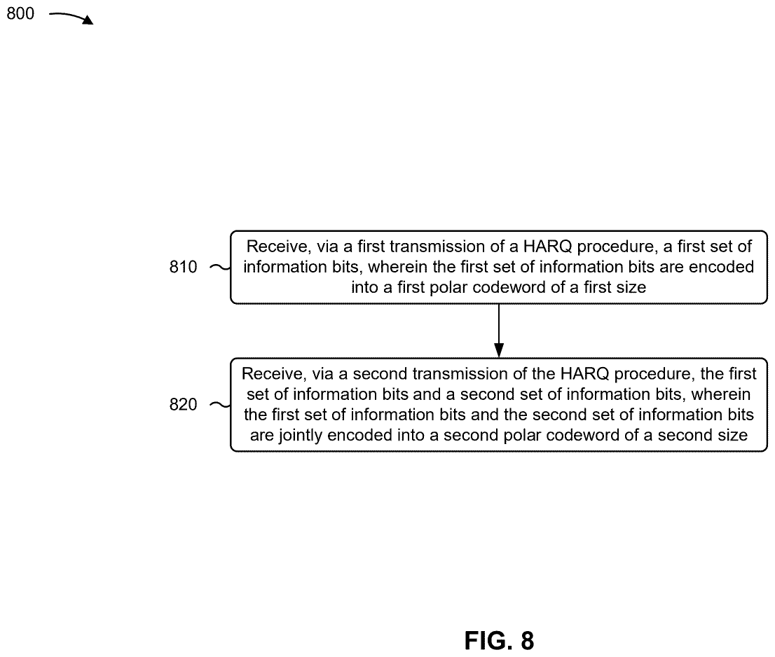

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with polar HARQ, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). In some aspects, the wireless communication device described herein is the network node 110, is included in the network node 110, or includes one or more components of the network node 110 shown in FIG. 1. In some aspects, the wireless communication device described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

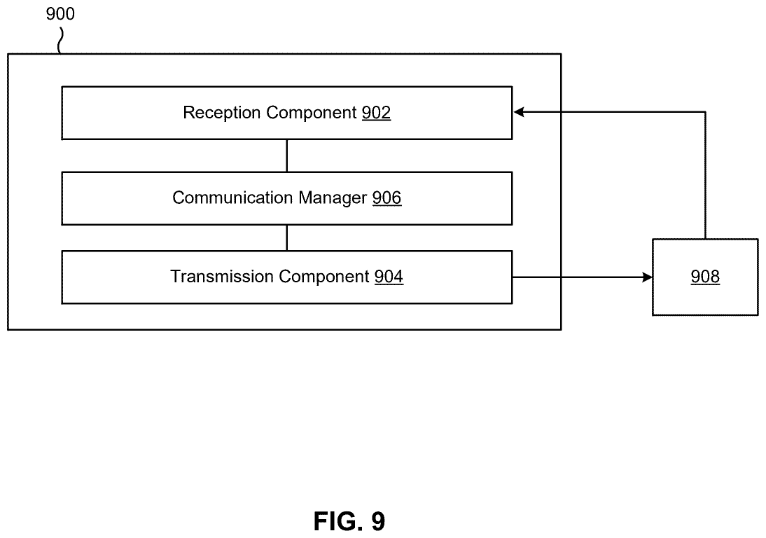

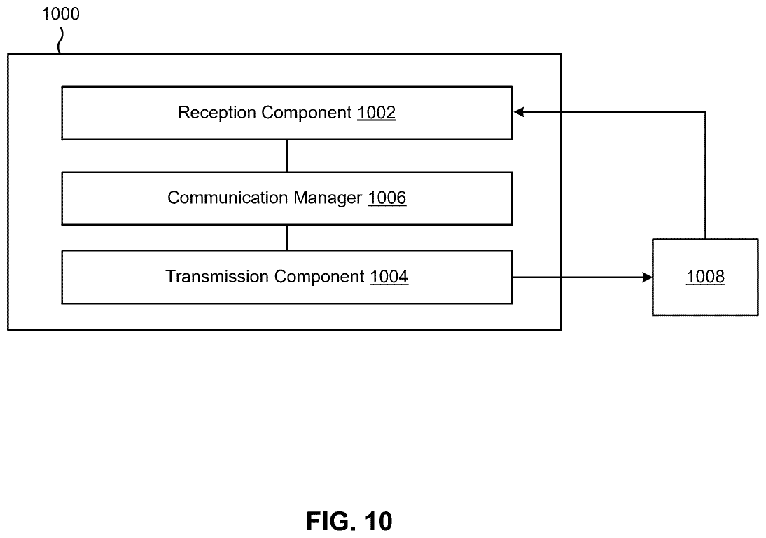

In some aspects, a wireless communication device (e.g., a network node 110 or a UE 120) includes means for transmitting, via a first transmission of a HARQ procedure, a first set of information bits, wherein the first set of information bits are encoded into a first polar codeword of a first size; and/or means for transmitting, via a second transmission of the HARQ procedure, the first set of information bits and a second set of information bits, wherein the first set of information bits and the second set of information bits are jointly encoded into a second polar codeword of a second size. In some aspects, the means for the wireless communication device to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 19), among other examples. In some aspects, the means for the wireless communication device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

In some aspects, the wireless communication device (e.g., a network node 110 or a UE 120) includes means for receiving, via a first transmission of a HARQ procedure, a first set of information bits, wherein the first set of information bits are encoded into a first polar codeword of a first size; and/or means for receiving, via a second transmission of the HARQ procedure, the first set of information bits and a second set of information bits, wherein the first set of information bits and the second set of information bits are jointly encoded into a second polar codeword of a second size. In some aspects, the means for the wireless communication device to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples. In some aspects, the means for the wireless communication device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

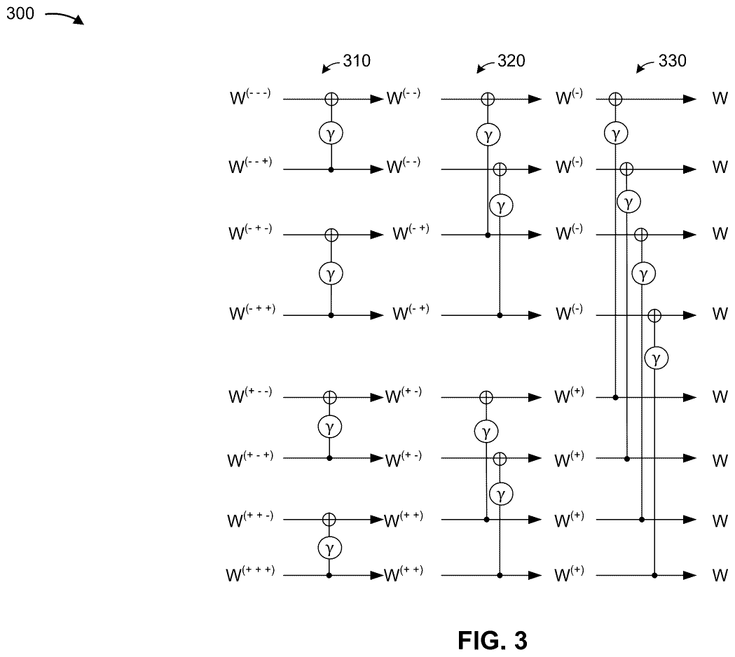

FIG. 3 is a diagram illustrating an example of a polar coding operation 300, in accordance with the present disclosure.

Wireless communications may be encoded using polar coding to improve resilience to non-ideal channel conditions. Polar encoding may involve constructing a codeword c having a length N. In some examples, encoding with an (N=2^{m}, K) code defined over a Galois Field (GF) with four elements (GF(4)), the codeword

$$c = {u ( \begin{matrix}1 & 0 \\ γ & 1\end{matrix} )}^{⊗ m} ,$$

where uᵢ, cᵢ∈GF(4) and γ is an element of GF(4) not equal to 0 or 1. A symbol uᵢ of an encoded communication may carry information (e.g., a two-bit payload in GF(4) or a one-bit payload in GF(2)) or may be frozen (e.g., having a fixed value, such as uᵢ=0). N may be referred to herein as a value defining a plurality of symbols of the encoded communication. In the binary case (GF(2)), γ=1.

The matrix

$${( \begin{matrix}1 & 0 \\ γ & 1\end{matrix} )}^{⊗ m}$$

may polarize 2^{m} copies of a channel W into subchannels W⁽ⁱ⁾, which may be almost noisy (e.g., I(W⁽ⁱ⁾)→0) or almost noiseless (e.g., I(W⁽ⁱ⁾)→2). As an example, subchannels W⁽ⁱ⁾ may be polarized into highly reliable (e.g., low noise) subchannels W⁽ⁱ⁾ and highly unreliable (e.g., noisy) subchannels W⁽ⁱ⁾. For example, for GF(4), the capacities of the subchannels W⁽ⁱ⁾, I(W⁽ⁱ⁾), may approach two for highly reliable subchannels W⁽ⁱ⁾ and 0 for highly unreliable subchannels W⁽ⁱ⁾. If GF(2), γ=1, and subchannels W⁽ⁱ⁾ may be present where the capacities I(W⁽ⁱ⁾) approach one (e.g., I(W⁽ⁱ⁾)→1).

Polar coding provides for a set of information symbols i₀, . . . i_{K-1} to be mapped to reliable symbol positions (referred to as information locations) and for unreliable symbols (in frozen locations) to be replaced with frozen symbols. For example, the information symbols i₀, . . . i₁ may correspond to the K largest capacities I(W⁽ⁱ⁾). For example, a transmitter may transmit the information symbols i₀, . . . i_{K-1} through the subchannels W⁽ⁱ⁾ that have the K largest capacities I(W⁽ⁱ⁾).

The polar encoding operation 300 may include coupling a plurality of subchannels W⁽ⁱ⁾ CG over multiple phases 310-330. Phase 310 involves coupling neighboring subchannels W⁽ⁱ⁾. Phase 320 involves coupling subchannels W⁽ⁱ⁾ separated by one subchannel W⁽ⁱ⁾. Phase 330 involves coupling subchannels W⁽ⁱ⁾ separated by three subchannels W⁽ⁱ⁾. Polar decoding may involve performing the polar encoding operation 300 in reverse (e.g., phase 330, followed by phase 320, followed by phase 310).

Polar coding is described herein with reference to a general kernel

$$G = ( \begin{matrix}1 & 0 \\ γ & 1\end{matrix} ) ,$$

where for GF(4), γ∈{1, α, α²}, and a is the primitive element of GF(2²). Thus, the elements of GF(2²) may include {0, 1, α, α²=a+1}, which may be considered as the elements {00, 01, 10, 11} of a two-dimensional vector space over GF(2). The summation of the elements may be defined coordinate-wise (e.g., where each coordinate is a single bit), and for multiplication of the elements, the following properties may be used: 0·x=0, 1·x=x, and α³=1. In some cases, for encoding in nonbinary polar coding, a recursive structure

$${( \begin{matrix}1 & 0 \\ γ & 1\end{matrix} )}^{⊗ m}$$

may be used. For GF(2), the general kernel

$$G = ( \begin{matrix}1 & 0 \\ γ & 1\end{matrix} )$$

and for encoding in binary polar coding, a recursive structure

$${( \begin{matrix}1 & 0 \\ 1 & 1\end{matrix} )}^{⊗ m}$$

may be used.

As indicated above, FIG. 3 is provided as an example. Other examples may differ from what is described with respect to FIG. 3.

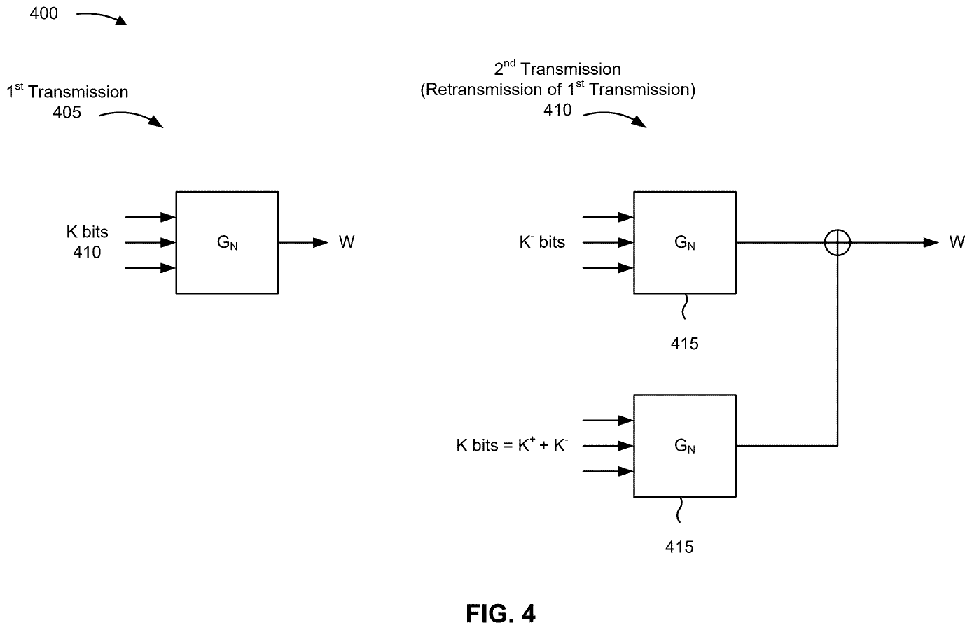

FIG. 4 is a diagram illustrating an example 400 of polar coding copy-based HARQ procedure, in accordance with the present disclosure. As used herein, “HARQ procedure” may refer to any type hybrid automatic repeat request procedure such as, for example, a procedure associated with performing IR-HARQ, chase-combining (CC)-HARQ, HARQ repetitions, and/or HARQ retransmissions.

As shown in FIG. 4, a wireless communication device (e.g., a network node 110 or a UE 120) may use polar coding to perform a first transmission 405 of a set of information bits 410 (e.g., K information bits, as shown in FIG. 4). For example, the wireless communication device may encode the set of information bits 410 using a first polar code of a first size (e.g., size N), yielding a first set of encoded bits (e.g., a first codeword). In some cases, the set of information bits 410 may be mapped to reliable symbol positions and unreliable symbols (in frozen locations) may be replaced with frozen symbols to generate the first codeword, in a manner similar to that described above with respect to FIG. 3.

In some cases, to provide coding gain, a quantity of encoded bits included in the first codeword may be greater than a quantity of bits included in the set of information bits 410. In some cases, the wireless communication device may transmit the first set of encoded bits to a receiving device (e.g., a network node 110 or a UE 120) via a communication channel W.

In some aspects, the wireless communication device may perform a second transmission 415 of the set of information bits 410. For example, the receiving device may receive the first codeword but may fail to successfully decode the first codeword. In such cases, the transmitting device may determine that the decoding was unsuccessful (e.g., based on receiving an indication (e.g., a NACK) from the receiving device or failing to receive any response from the receiving device) and may prepare a retransmission (e.g., the second transmission 415) of the set of information bits 410.

In some cases, when preparing the retransmission, the wireless communication device may generate a second set of encoded bits using a second polar code of the first size (e.g., size N) and a portion of the first set of encoded bits. In some cases, the set of information bits 410 may be grouped into a first subset of information bits (e.g., K⁺, as shown in FIG. 4) and a second subset of information bits (e.g., K⁻, as shown in FIG. 4).

In some cases, the first subset of information bits may correspond to a subset of the set of information bits 410 that were mapped to symbol positions that were determined to be more reliable relative to symbol positions to which the second subset of information bits were mapped. The wireless communication device may copy the second subset of information bits and may use the second polar code of the first size to assign the second subset of information bits to a set of reliable symbol positions and to assign frozen bits to the unreliable symbol positions for the second transmission 415.

In some cases, the wireless communication may perform an XOR operation on the first set of encoded bits and the output of the second polar code. By using logic 0's as the frozen bits, the output of the XOR operation may result in the same bit values as the first set of encoded bits. Thus, the bit values used for the second set of encoded bits may be the same as the first set of encoded bits.

In some cases, the first and second sets of encoded bits together may be considered as making up a second codeword. Although the first and second sets of encoded bits may be generated using polar codes of the first size (e.g., size N), the second codeword including the first and second sets of encoded bits may have a larger effective size (e.g., size 2N). Thus, even though the first and second sets of encoded bits are generated separately (e.g., at different times), the first and second sets of encoded bits are jointly polarized to generate the second codeword.

As indicated above, FIG. 4 is provided as an example. Other examples may differ from what is described with respect to FIG. 4.

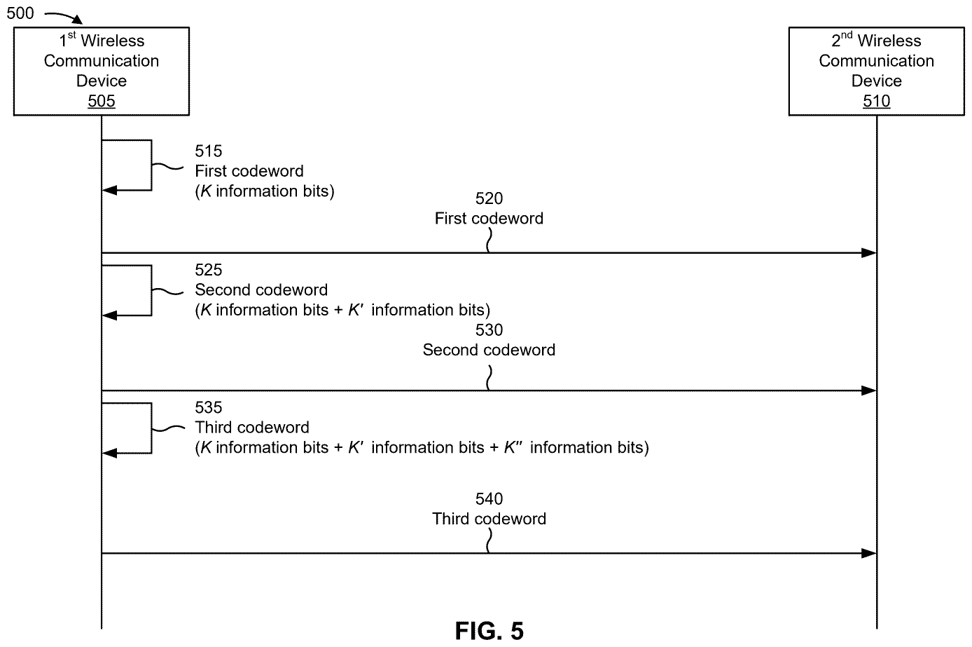

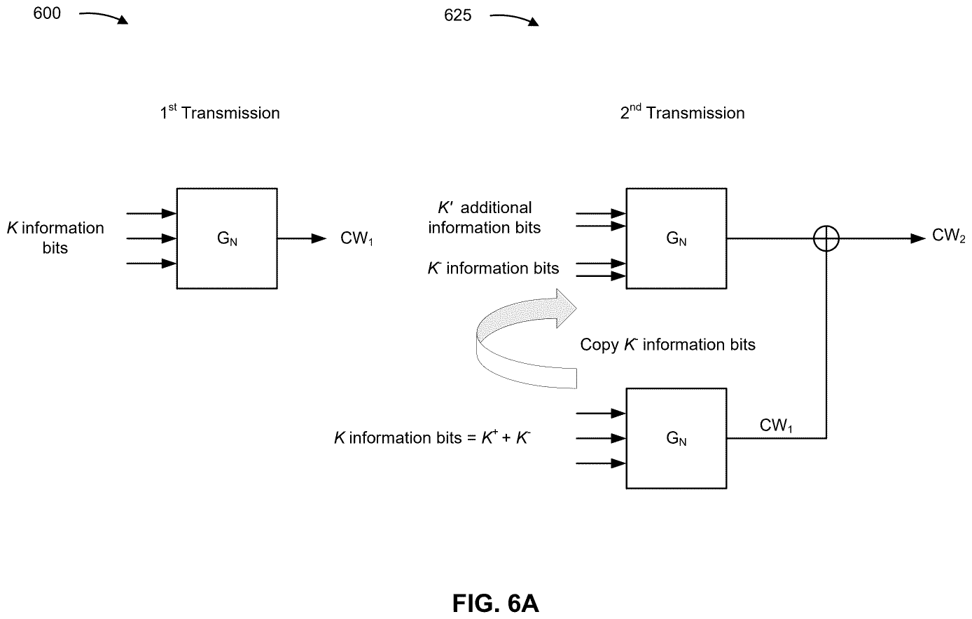

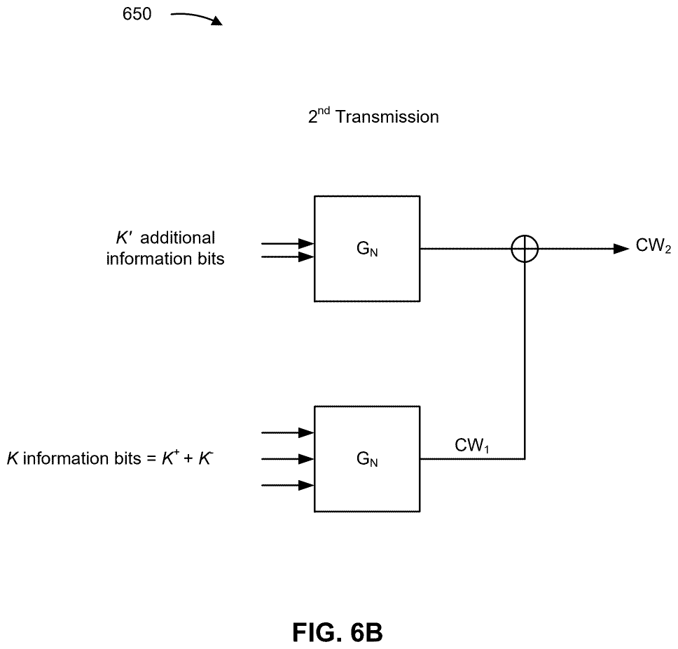

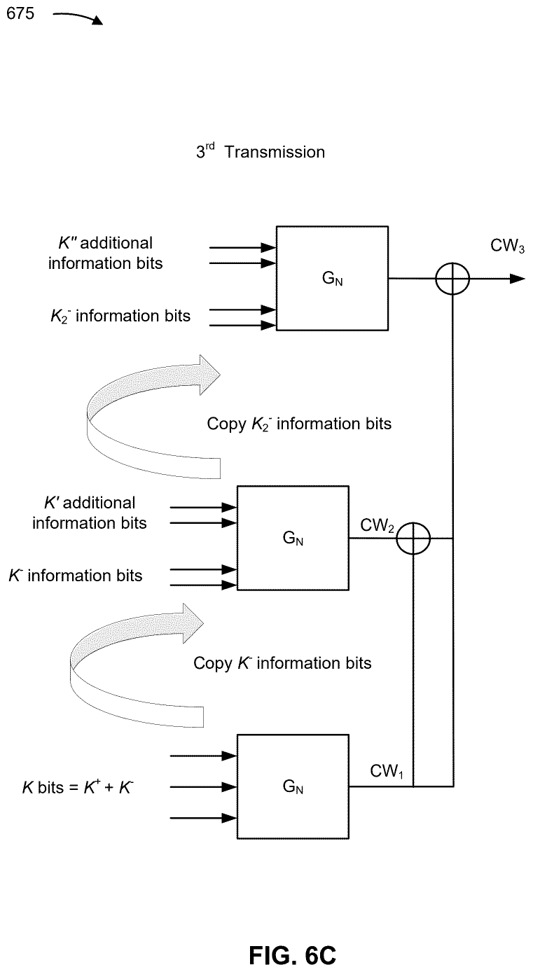

FIGS. 5 and 6A-6C are diagrams illustrating examples 500, 600, 625, 650, 675 associated with polar HARQ, in accordance with the present disclosure. As shown in FIG. 5, a first wireless communication device 505 (e.g., a first network node 110 or a first UE 120) and a second wireless communication device 510 (e.g., a second network node 110 or a second UE 120) may communicate with one another.

As shown by reference number 515, the first wireless communication device 505 may generate a first codeword based at least in part on a first set of information bits (K information bits, as shown in FIGS. 5, 6A, and 6C). For example, as shown by example 600 in FIG. 6A, the first wireless communication device 505 may use a first polar code of a first size (e.g., size N) to encode a first set of information bits forming a first codeword (e.g., CW₁, as shown in FIG. 6A).

As shown in FIG. 5, and by reference number 520, the first wireless communication device 505 may perform a first transmission to transmit the first codeword to the second wireless communication device 510. In some aspects, the first wireless communication device 505 may be configured for transmissions with repetitions.

For example, the first transmission may correspond to a PUCCH transmission from the first wireless communication device 505 (e.g., a UE 120) to the second wireless communication device 510 (e.g., a network node 110). The first wireless communication device 505 may be configured to perform an initial transmission (e.g., the first transmission) of the first set of information bits via a first set of resources scheduled for the first wireless communication device 505. The first wireless communication device 505 may be configured to perform one or more additional transmissions (e.g., one or more repetitions of the initial transmission) of the first set of information bits in a second set of resources scheduled for the first wireless communication device 505 (e.g., to enable the second wireless communication device 510 to perform soft combining of the initial transmission and the one or more repetitions of the initial transmission).

In some aspects, the second wireless communication device 510 may additionally schedule the first wireless communication device 505 to transmit a first set of additional information bits (e.g., K′ information bits, as shown in FIGS. 5, 6A, and 6C) via the second set of resources. In some aspects, the first wireless communication device 505 may prepare a second transmission for transmitting the first set of information bits (e.g., based at least in part on the first wireless communication device 505 being configured to transmit the first set of information bits with repetitions) and the first set of additional information bits (e.g., based at least in part on the first wireless communication device 505 being scheduled to transmit the second set of information bits via the second set of resources), as described below.

In some aspects, the first wireless communication device 505 may perform a second transmission of the first set of information bits based at least in part on the first transmission being unsuccessful. For example, the second wireless communication device 510 may fail to receive the first transmission or may receive the first transmission but may fail to successfully decode the first codeword.

In some aspects, the second wireless communication device 510 may utilize the second subset of information bits as parity check bits during a decoding process. The second wireless communication device 510 may determine that the second wireless communication device 510 has failed to successfully decode the first codeword based at least in part on utilizing the second subset of information bits as parity check bits during the decoding process. In these aspects, the first wireless communication device 505 may determine that the first transmission was not received by the second wireless communication device 510 and/or that the second wireless communication device 510 failed to successfully decode the first codeword.

For example, the first wireless communication device 505 may receive an indication (e.g., a NACK) from the second wireless communication device 510 and may determine that the second wireless communication device 510 failed to successfully decode the first codeword based at least in part on receiving the indication. The first wireless communication device 505 may prepare a second transmission of the first set of information bits (e.g., a HARQ retransmission) based at least in part on the second wireless communication device 510 failing to successfully decode the first codeword.

As another example, the first wireless communication device 505 may fail to receive (e.g., within a threshold amount of time) a response (e.g., an ACK or another type of response transmitted by the second wireless communication device 510 based at least in part on receiving and successfully decoding the first codeword) from the second wireless communication device 510. The first wireless communication device 505 may determine that the first transmission of the first set of information bits was unsuccessful (e.g., the second wireless communication device 510 failed to receive the first transmission and/or failed to successfully decode the first codeword) based at least in part on failing to receive a response from the second wireless communication device 510. The first wireless communication device 505 may prepare a second transmission of the first set of information bits (e.g., a HARQ repetition) based at least in part on the first transmission of the first set of information bits being unsuccessful.

Additionally, or alternatively, the first wireless communication device 505 may prepare a second transmission for retransmitting the first set of information bits to the second wireless communication device 510 based at least in part on the first wireless communication device 505 being configured to transmit repetitions of the first set of information bits. For example, the first wireless communication device 505 may be configured to perform a quantity of IR-HARQ repetitions and the first wireless communication device 505 may prepare a second transmission for retransmitting the first set of information bits to the second wireless communication device 510 based at least in part on being configured to perform the quantity of IR-HARQ repetitions.

In some aspects, the first wireless communication device 505 may need to add a first set of additional information bits (e.g., K′ information bits, as shown in FIGS. 5, 6A, and 6C) to the second transmission (e.g., a retransmission) of the first set of information bits. In some aspects, the first wireless communication device 505 may generate and/or receive additional data (e.g., one or more additional information bits corresponding to the first set of additional information bits) to be transmitted to the second wireless communication device 510 and the first wireless communication device 505 may add the additional data to the second transmission of the first set of information bits.

In some aspects, the additional data may be associated with a higher priority relative to a priority associated with the retransmission of the first set of information bits. In these aspects, the first wireless communication device 505 may add the additional data to the second transmission of the first set of information bits based at least in part on the additional data being associated with the higher priority.

As an example, the first set of information bits may comprise first UCI and the one or more new information bits may comprise second UCI. The second UCI may be associated with a higher priority relative to a priority associated with a retransmission of the first UCI.

In some aspects, the first wireless communication device 505 may determine whether to add the first set of additional information bits to the second transmission based at least in part on whether one or more conditions are satisfied. In some aspects, the one or more conditions may include whether a ratio of a quantity of bits included in the first set of additional information bits and a quantity of bits included in the first set of information bits satisfies (e.g., is less than) a threshold.

In some aspects, the first wireless communication device 505 may include the first set of additional information bits in the second transmission based at least in part on the ratio of the quantity of bits included in the first set of additional information bits and the quantity of bits included in the first set of information bits satisfies the threshold. For example, the first wireless communication device 505 may include the first set of additional information bits in the second transmission when the ratio of the quantity of bits included in the first set of additional information bits and the quantity of bits included in the first set of information bits is less than 1/5, 1/6, or 1/10, among other examples.

In some aspects, the first wireless communication device 505 may refrain from including the first set of additional information bits (or may refrain from transmitting the second transmission) based at least in part on the ratio of the of the quantity of bits included in the first set of additional information bits and the quantity of bits included in the first set of information bits failing to satisfy the threshold. For example, the first wireless communication device 505 may refrain from including the first set of additional information bits in the second transmission when the ratio of the quantity of bits included in the first set of additional information bits and the quantity of bits included in the first set of information bits is greater than or equal to 1/5, 1/6, or 1/10, among other examples.

In some aspects, the threshold may be determined based at least in part the quantity of bits included in the first set of information bits (e.g., K) and the first size (e.g., N) of the first polar code. In some aspects, the function may correspond to:

$$\frac{{K}^{2}}{N} .$$

In these aspects, the first set of additional information bits may be included in the second transmission based at least in part on whether:

$${K}^{′} \leq \frac{{K}^{2}}{N} .$$

As shown by reference number 525, the first wireless communication device 505 may generate a second codeword based at least in part on a portion of the first set of information bits and a first set of additional information bits (e.g., K′ information bits, as shown in FIGS. 5 and 6A). In some aspects, when preparing the second transmission, the first wireless communication device 505 may generate a second set of encoded bits using a second polar code of the first size (e.g., size N) and a portion of the first set of encoded bits (e.g., K⁻ information bits, as shown in FIG. 6A). In some aspects, the first set of information bits may be grouped into a first subset of information bits (e.g., K⁺, as shown in example 625 of FIG. 6A) and a second subset of information bits (e.g., K⁻, as shown in example 625 of FIG. 6A).

In some aspects, the first subset of information bits may correspond to a subset of the first set of information bits that were mapped to symbol positions that were determined to be more reliable relative to symbol positions to which the second subset of information bits were mapped. The first wireless communication device 505 may copy the second subset of information bits and may use the second polar code of the first size to jointly include the second subset of information bits and the first set of additional information bits.

In some aspects, a quantity of bits included in the second subset of information bits may be determined based at least in part on a quantity of bits included in a first half of the polar transform. As an example, a total quantity of bits included in the first set of information bits and the first set of additional information bits may be represented as (K′+K). The quantity of bits in the second subset of information bits (e.g., K⁻) may be determined such that, if K′+K most reliable bits of a length 2N (or, more generally, N₁+N₂ when the first transmission and the second transmission utilize different quantities of resources) polar code were selected, there will be K′+K⁻ bits in a first half of the polar transform.

In some aspects, the second subset of information bits and the first set of additional information bits may be mapped to a first half of polar codes. In some aspects, the first wireless communication device 505 may perform an XOR operation on the first set of encoded bits and the output of the second polar code to generate a second codeword (e.g., CW₂, as shown in example 625 of FIG. 6A).

In these aspects, performing the XOR operation on the first set of encoded bits and the output of the second polar code may combine the first set of encoded bits and the output of the second polar code. The combination of the first set of encoded bits and the output of the second polar code may correspond to a larger, joint polar code. For example, performing an XOR operation on a first polar code of a first size (N) (e.g., the first set of encoded bits) and a second polar code of the first size (N) (e.g., the output of the second polar code) may result in a joint polar code of a second size (2N) based at least in part on concatenating the first and second polar codes together.

In some aspects, the second wireless communication device 510 may utilize a single length (e.g., 2N) decoder to jointly decode the first set of encoded bits and the output of the second polar code. In some aspects, by jointly coding the first set of encoded bits and the output of the second polar code, there will be a coding gain relative to a scenario in which the first set of encoded bits and the output of the second polar code are separately encoded.

In some aspects, as shown in FIG. 6B and by example 650, the first wireless communication device 505 may generate the second codeword based at least in part on only the first set of additional information bits (e.g., K′ information bits, as shown in FIG. 6B). Stated differently, when preparing the second transmission, the first wireless communication device 505 may not use the second subset of information bits to generate the second set of encoded bits. For example, the first wireless communication device 505 may be configured to set K⁻ equal to zero. The first wireless communication device 505 may generate the second codeword based at least in part on only the first set of additional information bits based at least in part on K⁻ being set equal to zero.

In these aspects, the output of the second polar code may only contain information associated with the first set of additional information bits. In some aspects, the first wireless communication device 505 may perform an XOR operation on the first set of encoded bits and the output of the second polar code to generate the second codeword. Because the XOR operation was performed on the first set of encoded bits and the output of the second polar code, the second codeword may still carry information associated with the first set of information bits.

In some aspects, the second wireless communication device 510 may jointly decode the first set of additional information bits and the first set of information bits. In some aspects, the second wireless communication device 510 may concatenate the signal of the second codeword and the first codeword. The second wireless communication device 510 may pass over one single polar code based at least in part on concatenating the signal of the second codeword and the first codeword. In some aspects, because the second subset of information bits was not utilized to generate the output of the second polar code, the second wireless communication device 510 may utilize a decoder of a length 2N (or, more generally, N₁+N₂ when the first transmission and the second transmission utilize different quantities of resources) to decode the first set of additional information bits and the first set of information bits.

In some aspects, the first wireless communication device 505 may add one or more CRC bits to the first set of additional information bits. In some aspects, the one or more CRC bits added to the first set of additional bits may be generated separately from a CRC generated for the first set of information bits. In some aspects, the one or more CRC bits added to the first set of additional bits may be generated separately from the CRC generated for the first set of information bits based at least in part on a quantity of bits included in the first set of additional information bits satisfying (e.g., being greater than) a threshold. In some aspects, the first set of information bits and the first set of additional information bits may share a common CRC based at least in part on the quantity of bits included in the first set of additional information bits failing to satisfy (e.g., being less than or equal to) the threshold.

As shown in FIG. 5, and by reference number 530, the first wireless communication device 505 may transmit the second codeword to the second wireless communication device 510. In some aspects, the second wireless communication device 510 may fail to receive the second transmission or may receive the second transmission but may fail to successfully decode the second codeword.

For example, the second wireless communication device 510 may utilize the second subset of the first set of additional information bits as parity check bits during a decoding process. The second wireless communication device 510 may determine that the second wireless communication device 510 has failed to successfully decode the first codeword based at least in part on utilizing the second subset of the first set of additional information bits as parity check bits during the decoding process. In these aspects, the first wireless communication device 505 may determine that the second transmission was not received by the second wireless communication device 510 and/or that the second wireless communication device 510 failed to successfully decode the second codeword.

For example, the first wireless communication device 505 may receive an indication (e.g., a NACK) from the second wireless communication device 510 and may determine that the second wireless communication device 510 failed to successfully decode the second codeword based at least in part on receiving the indication. As another example, the first wireless communication device 505 may fail to receive (e.g., within a threshold amount of time) a response (e.g., an ACK or another type of response transmitted by the second wireless communication device 510 based at least in part on receiving and successfully decoding the second codeword) from the second wireless communication device 510. The first wireless communication device 505 may determine that the second wireless communication device 510 failed to receive the second transmission and/or failed to successfully decode the second codeword based at least in part on failing to receive a response from the second wireless communication device 510.

In some aspects, the first wireless communication device 505 may prepare a third transmission for retransmitting the first set of information bits and the first set of additional information bits to the second wireless communication device 510 based at least in part on the second wireless communication device 510 failing to receive the second transmission and/or failing to successfully decode the second codeword.

Additionally, or alternatively, the first wireless communication device 505 may prepare a third transmission for retransmitting the first set of information bits and the first set of additional information bits to the second wireless communication device 510 based at least in part on the first wireless communication device 505 being configured to transmit repetitions of the first set of information bits and/or the first set of additional information bits.

In some aspects, the first wireless communication device 505 may need to add a second set of additional information bits (e.g., K″ information bits, as shown in FIGS. 5 and 6C) to the third transmission. For example, the first wireless communication device 505 may generate and/or receive additional data (e.g., one or more additional information bits corresponding to the second set of additional information bits) to be transmitted to the second wireless communication device 510 and the additional data may be associated with a higher priority relative to a priority associated with the retransmission of the first set of information bits and/or a retransmission of the first set of additional information bits.

In some aspects, the first wireless communication device 505 may determine whether to add the second set of additional information bits to the third transmission based at least in part on whether one or more conditions are satisfied. In some aspects, the first wireless communication device 505 may determine whether to add the second set of additional information bits to the third transmission in a manner similar to that described above with respect to the first set of additional information bits.

As shown by reference number 535, the first wireless communication device 505 may generate a third codeword based at least in part on a portion of the first set of additional information bits and the second set of additional information bits (e.g., K″ information bits, as shown in FIGS. 5 and 6C). In some aspects, when preparing the third transmission, the first wireless communication device 505 may generate a third set of encoded bits using a third polar code of the first size (e.g., size N) and the second set of additional information bits. For example, the first wireless communication device 505 may generate the third set of encoded bits in a manner similar to that described above with respect to FIG. 6B.

In some aspects, the first wireless communication device 505 may generate the third set of encoded bits using the third polar code of the first size, the second set of additional information bit, and a portion of the first set of additional information bits (e.g.,

$${K}_{2}^{-}$$

information bits, as shown in FIG. 6C). In some aspects, the first set of additional information bits may be grouped into a first subset of the first set of additional information bits (e.g.,

$${K}_{2}^{+}$$

information bits, as shown in example 650 of FIG. 6C) and a second subset of the first set of additional information bits (e.g.,

$${K}_{2}^{-}$$

information bits, as shown in example 650 of FIG. 6C).

In some aspects, the first subset of the first set of additional information bits may correspond to a subset of the first set of additional information bits that were mapped to symbol positions that were determined to be more reliable relative to symbol positions to which the second subset of additional information bits were mapped. The first wireless communication device 505 may copy the second subset of the first set of additional information bits and may use the third polar code of the first size to jointly include the second subset of the first set of additional information bits and the second set of additional information bits.

In some aspects, a quantity of bits included in the second subset of the first set of additional information bits may be determined based at least in part on a quantity of bits included in a first half of the polar transform. As an example, a total quantity of bits included in the first set of information bits, the first set of additional information bits, and the second set of additional information bits may be represented as (K″+K′+K). In some aspects, the second transmission may be performed without adding the first set of additional information bits. In these aspects, K′ may be set equal to zero to represent that additional information bits were not added to the second transmission. The quantity of bits in the second subset of the first set of additional information bits

$$( e . g . , {K}_{2}^{-} )$$

may be determined such that, if K″+K′+K most reliable bits of a length 3N (or, more generally, N₁+N₂+N₃ when the first transmission, the second transmission, and/or the third transmission utilize different quantities of resources) polar code were selected, there will be K″+K′+K bits in a first half of the polar transform.

In some aspects, the second subset of the first set of additional information bits and the second set of additional information bits may be mapped to a first half of polar codes. In some aspects, the first wireless communication device 505 may perform an XOR operation on the first set of encoded bits and the output of the third polar code to generate a third codeword (e.g., CW₃, as shown in example 650 of FIG. 6C).

In some aspects, the second wireless communication device 510 may utilize a single length (e.g., 2N) decoder to jointly decode the third codeword (e.g., the second set of additional information bits, the first set of additional information bits, and the first set of information bits or, when the first set of additional information bits is not included in the second codeword, the second set of additional information bits and the first set of information bits). In some aspects, by jointly coding the first set of encoded bits, the output of the second polar code, and the output of the third polar code, there will be a coding gain relative to a scenario in which the first set of encoded bits and the output of the second polar code are separately encoded.

In some aspects, the first wireless communication device 505 may generate the second codeword and/or the third codeword based at least in part on only the first set of additional information bits and/or the second set of additional information bits, respectively. For example, the first wireless communication device 505 may be configured to set K⁻ equal to zero and/or to set K₂⁻ equal to zero.

In some aspects, the second wireless communication device 510 may concatenate the signal of the third codeword, the second codeword, and the first codeword. The second wireless communication device 510 may pass over one single polar code based at least in part on concatenating the signal of the third codeword, the second codeword, and the first codeword. In some aspects, because the second subset of information bits was not utilized to generate the output of the second polar code, the second wireless communication device 510 may utilize a decoder of a length 3N (or, more generally, N₁+N₂+N₃ when the first transmission, the second transmission, and/or the third transmission utilize different quantities of resources) to decode the first set of additional information bits, the second set of additional information bits, and the first set of information bits.

In some aspects, the first wireless communication device 505 may add one or more CRC bits to the second set of additional information bits. In some aspects, the one or more CRC bits added to the second set of additional bits may be generated separately from a CRC generated for the first set of additional information bits and/or a CRC generated for the first set of information bits. In some aspects, the one or more CRC bits added to the second set of additional bits may be generated separately from the CRC generated for the first set of additional information bits and/or the CRC generated for the first set of information bits based at least in part on a quantity of bits included in the second set of additional information bits satisfying (e.g., being greater than) a threshold. In some aspects, the first set of information bits, the first set of additional information bits, and/or the second set of additional information bits may share a common CRC based at least in part on the quantity of bits included in the second set of additional information bits failing to satisfy (e.g., being less than or equal to) the threshold.

As shown in FIG. 5, and by reference number 540, the first wireless communication device 505 may transmit the third codeword to the second wireless communication device 510. In some aspects, the first wireless communication device 505 may perform one or more additional transmissions of the first set of information bits, the first set of additional information bits, and/or the second set of additional information bits. In these aspects, the first wireless communication device 505 may add additional sets of additional information bits in a manner similar to that described above.

As indicated above, FIGS. 5 and 6A-6C are provided as an example. Other examples may differ from what is described with respect to FIGS. 5 and 6A-6C.

FIG. 7 is a diagram illustrating an example process 700 performed, for example, at a wireless communication device or an apparatus of a wireless communication device, in accordance with the present disclosure. Example process 700 is an example where the apparatus or the wireless communication device (e.g., a network node 110 or a UE 120) performs operations associated with polar HARQ.

As shown in FIG. 7, in some aspects, process 700 may include transmitting, via a first transmission of a HARQ procedure, a first set of information bits, wherein the first set of information bits are encoded into a first polar codeword of a first size (block 710). For example, the wireless communication device (e.g., using transmission component 904 and/or communication manager 906, depicted in FIG. 9) may transmit, via a first transmission of a HARQ procedure, a first set of information bits, wherein the first set of information bits are encoded into a first polar codeword of a first size, as described above.

As further shown in FIG. 7, in some aspects, process 700 may include transmitting, via a second transmission of the HARQ procedure, the first set of information bits and a second set of information bits, wherein the first set of information bits and the second set of information bits are jointly encoded into a second polar codeword of a second size (block 720). For example, the wireless communication device (e.g., using transmission component 904 and/or communication manager 906, depicted in FIG. 9) may transmit, via a second transmission of the HARQ procedure, the first set of information bits and a second set of information bits, wherein the first set of information bits and the second set of information bits are jointly encoded into a second polar codeword of a second size, as described above.

Process 700 may include additional aspects, such as any single aspect or any combination of aspects described below and/or in connection with one or more other processes described elsewhere herein.

In a first aspect, the second set of information bits includes a set of new information bits and a set of copied information bits, wherein the set of copied information bits corresponds to a portion of the first set of information bits.

In a second aspect, alone or in combination with the first aspect, the set of copied information bits can be used as parity-check bits during a decoding process.

In a third aspect, alone or in combination with one or more of the first and second aspects, the second set of information bits is included in the second transmission based at least in part on a quantity of bits included in the second set of information bits satisfying a condition.

In a fourth aspect, alone or in combination with one or more of the first through third aspects, the second set of information bits is not included in the second transmission when the quantity of bits included in the second set of information bits fails to satisfy the condition.

In a fifth aspect, alone or in combination with one or more of the first through fourth aspects, the quantity of bits included in the second set of information bits satisfies the condition based at least in part on the quantity of bits being less than or equal to a threshold.

In a sixth aspect, alone or in combination with one or more of the first through fifth aspects, the threshold is based at least in part on the first size and a quantity of bits included in the first set of information bits.

In a seventh aspect, alone or in combination with one or more of the first through sixth aspects, process 700 includes generating a first set of CRC bits based at least in part on the first set of information bits, and generating a second set of CRC bits based at least in part on the second set of information bits.

In an eighth aspect, alone or in combination with one or more of the first through seventh aspects, the second set of CRC bits is included in the second transmission of the HARQ procedure.

In a ninth aspect, alone or in combination with one or more of the first through eighth aspects, generating the first set of CRC bits comprises generating the first set of CRC bits is generated separately from the second set of CRC bits.

In a tenth aspect, alone or in combination with one or more of the first through ninth aspects, process 700 includes transmitting, via a third transmission of the HARQ procedure, the first set of information bits, the second set of information bits, and a third set of information bits, wherein the first set of information bits, the second set of information bits, and the third set of information bits are jointly encoded into a third polar codeword of a third size.

In an eleventh aspect, alone or in combination with one or more of the first through tenth aspects, process 700 includes utilizing a polar code to generate a set of encrypted bits based at least in part on the second set of information bits; and generating the second codeword based at least in part on performing an XOR operation on the first polar codeword and the set of encrypted bits.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a wireless communication device or an apparatus of a wireless communication device, in accordance with the present disclosure. Example process 800 is an example where the apparatus or the wireless communication device (e.g., a network node 110 or a UE 120) performs operations associated with polar HARQ.

As shown in FIG. 8, in some aspects, process 800 may include receiving, via a first transmission of a HARQ procedure, a first set of information bits, wherein the first set of information bits are encoded into a first polar codeword of a first size (block 810). For example, the wireless communication device (e.g., using reception component 1002 and/or communication manager 1006, depicted in FIG. 10) may receive, via a first transmission of a HARQ procedure, a first set of information bits, wherein the first set of information bits are encoded into a first polar codeword of a first size, as described above.

As further shown in FIG. 8, in some aspects, process 800 may include receiving, via a second transmission of the HARQ procedure, the first set of information bits and a second set of information bits, wherein the first set of information bits and the second set of information bits are jointly encoded into a second polar codeword of a second size (block 820). For example, the wireless communication device (e.g., using reception component 1002 and/or communication manager 1006, depicted in FIG. 10) may receive, via a second transmission of the HARQ procedure, the first set of information bits and a second set of information bits, wherein the first set of information bits and the second set of information bits are jointly encoded into a second polar codeword of a second size, as described above.

Process 800 may include additional aspects, such as any single aspect or any combination of aspects described below and/or in connection with one or more other processes described elsewhere herein.

In a first aspect, the second set of information bits includes a set of new information bits and a set of copied information bits, wherein the set of copied information bits corresponds to a portion of the first set of information bits.

In a second aspect, alone or in combination with the first aspect, process 800 includes using the set of copied information bits as parity-check bits during a decoding process.

In a third aspect, alone or in combination with one or more of the first and second aspects, the second set of information bits is included in the second transmission based at least in part on a quantity of bits included in the second set of information bits satisfying a condition.

In a fourth aspect, alone or in combination with one or more of the first through third aspects, the second set of information bits is not included in the second transmission when the quantity of bits included in the second set of information bits failing to satisfy the condition.

In a fifth aspect, alone or in combination with one or more of the first through fourth aspects, the quantity of bits included in the second set of information bits satisfies the condition based at least in part on the quantity of bits being less than or equal to a threshold.

In a sixth aspect, alone or in combination with one or more of the first through fifth aspects, the threshold is based at least in part on the first size and a quantity of bits included in the first set of information bits.

In a seventh aspect, alone or in combination with one or more of the first through sixth aspects, the first set of information bits is associated with a first set of CRC bits that is generated based at least in part on the first set of information bits and the second set of information bits is associated with a second set of CRC bits that is generated based at least in part on the second set of information bits.

In an eighth aspect, alone or in combination with one or more of the first through seventh aspects, the second set of CRC bits is included in the second transmission of the HARQ procedure.

In a ninth aspect, alone or in combination with one or more of the first through eighth aspects, the first set of CRC bits is generated separately from the second set of CRC bits.

In a tenth aspect, alone or in combination with one or more of the first through ninth aspects, process 800 includes receiving, via a third transmission of the HARQ procedure, the first set of information bits, the second set of information bits, and a third set of information bits, wherein the first set of information bits, the second set of information bits, and the third set of information bits are jointly encoded into a third polar codeword of a third size.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a wireless communication device (e.g., a network node 110 or a UE 120), or a wireless communication device may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 or the processing system 145 described in connection with FIG. 1) of the wireless communication device.

In some aspects, the apparatus 900 may be configured to perform one or more operations described herein in connection with FIGS. 3-5 and 6A-6C. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node 110 or the UE 120 described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 902 may include one or more components of the UE 120 described above in connection with FIG. 1, such as a radio, one or more RF chains, one or more transceivers, or one or more modems, each of which may in turn be coupled with one or more antennas of the UE 120.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 904 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, via a first transmission of a HARQ procedure, a first set of information bits, wherein the first set of information bits are encoded into a first polar codeword of a first size. The transmission component 904 may transmit, via a second transmission of the HARQ procedure, the first set of information bits and a second set of information bits, wherein the first set of information bits and the second set of information bits are jointly encoded into a second polar codeword of a second size.

The communication manager 906 may generate a first set of CRC bits based at least in part on the first set of information bits.

The communication manager 906 may generate a second set of CRC bits based at least in part on the second set of information bits.

The transmission component 904 may transmit, via a third transmission of the IR-HARQ procedure, the first set of information bits, the second set of information bits, and a third set of information bits, wherein the first set of information bits, the second set of information bits, and the third set of information bits are jointly encoded into a third polar codeword of a third size.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a wireless communication device (e.g., a network node 110 or a UE 120), or a wireless communication device may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 or the processing system 145 described in connection with FIG. 1) of the wireless communication device.

In some aspects, the apparatus 1000 may be configured to perform one or more operations described herein in connection with FIGS. 3-5 and 6A-6C.

Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node 110 or the UE 120 described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 1002 may include one or more components of the UE 120 described above in connection with FIG. 1, such as a radio, one or more RF chains, one or more transceivers, or one or more modems, each of which may in turn be coupled with one or more antennas of the UE 120.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 1004 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, via a first transmission of a HARQ procedure, a first set of information bits, wherein the first set of information bits are encoded into a first polar codeword of a first size. The reception component 1002 may receive, via a second transmission of the HARQ procedure, the first set of information bits and a second set of information bits, wherein the first set of information bits and the second set of information bits are jointly encoded into a second polar codeword of a second size.

The communication manager 1006 may use the set of copied information bits as parity-check bits during a decoding process.

The reception component 1002 may receive, via a third transmission of the HARQ procedure, the first set of information bits, the second set of information bits, and a third set of information bits, wherein the first set of information bits, the second set of information bits, and the third set of information bits are jointly encoded into a third polar codeword of a third size.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a wireless communication device, comprising: transmitting, via a first transmission of a HARQ procedure, a first set of information bits, wherein the first set of information bits are encoded into a first polar codeword of a first size; and transmitting, via a second transmission of the HARQ procedure, the first set of information bits and a second set of information bits, wherein the first set of information bits and the second set of information bits are jointly encoded into a second polar codeword of a second size.
Aspect 2: The method of Aspect 1, wherein the second set of information bits includes a set of new information bits and a set of copied information bits, wherein the set of copied information bits corresponds to a portion of the first set of information bits.
Aspect 3: The method of Aspect 2, wherein the set of copied information bits can be used as parity-check bits during a decoding process.
Aspect 4: The method of Aspect 2, further comprising utilizing a polar code to generate a set of encrypted bits based at least in part on the second set of information bits; and generating the second codeword based at least in part on performing an XOR operation on the first polar codeword and the set of encrypted bits.
Aspect 5: The method of any of Aspects 1-4, wherein the second set of information bits is included in the second transmission based at least in part on a quantity of bits included in the second set of information bits satisfying a condition.
Aspect 6: The method of Aspect 5, wherein the second set of information bits is not included in the second transmission when the quantity of bits included in the second set of information bits fails to satisfy the condition.
Aspect 7: The method of Aspect 5, wherein the quantity of bits included in the second set of information bits satisfies the condition based at least in part on the quantity of bits being less than or equal to a threshold.
Aspect 8: The method of Aspect 7, wherein the threshold is based at least in part on the first size and a quantity of bits included in the first set of information bits.
Aspect 9: The method of any of Aspects 1-8, further comprising: generating a first set of CRC bits based at least in part on the first set of information bits; and generating a second set of CRC bits based at least in part on the second set of information bits.
Aspect 10: The method of Aspect 9, wherein the second set of CRC bits is included in the second transmission of the HARQ procedure.
Aspect 11: The method of Aspect 9, wherein generating the first set of CRC bits comprises: generating the first set of CRC bits is generated separately from the second set of CRC bits.
Aspect 12: The method of any of Aspects 1-11, further comprising: transmitting, via a third transmission of the HARQ procedure, the first set of information bits, the second set of information bits, and a third set of information bits, wherein the first set of information bits, the second set of information bits, and the third set of information bits are jointly encoded into a third polar codeword of a third size.
Aspect 13: A method of wireless communication performed by a wireless communication device, comprising: receiving, via a first transmission of a HARQ procedure, a first set of information bits, wherein the first set of information bits are encoded into a first polar codeword of a first size; and receiving, via a second transmission of the HARQ procedure, the first set of information bits and a second set of information bits, wherein the first set of information bits and the second set of information bits are jointly encoded into a second polar codeword of a second size.
Aspect 14: The method of Aspect 13, wherein the second set of information bits includes a set of new information bits and a set of copied information bits, wherein the set of copied information bits corresponds to a portion of the first set of information bits.
Aspect 15: The method of Aspect 14, further comprising: using the set of copied information bits as parity-check bits during a decoding process.
Aspect 16: The method of any of Aspects 13-15, wherein the second set of information bits is included in the second transmission based at least in part on a quantity of bits included in the second set of information bits satisfying a condition.
Aspect 17: The method of Aspect 16, wherein the second set of information bits is not included in the second transmission when the quantity of bits included in the second set of information bits failing to satisfy the condition.
Aspect 18: The method of Aspect 16, wherein the quantity of bits included in the second set of information bits satisfies the condition based at least in part on the quantity of bits being less than or equal to a threshold.
Aspect 19: The method of Aspect 18, wherein the threshold is based at least in part on the first size and a quantity of bits included in the first set of information bits.
Aspect 20: The method of any of Aspects 13-19, wherein the first set of information bits is associated with a first set of CRC bits that is generated based at least in part on the first set of information bits and the second set of information bits is associated with a second set of CRC bits that is generated based at least in part on the second set of information bits.
Aspect 21: The method of Aspect 20, wherein the second set of CRC bits is included in the second transmission of the HARQ procedure.
Aspect 22: The method of Aspect 20, wherein the first set of CRC bits is generated separately from the second set of CRC bits.
Aspect 23: The method of any of Aspects 13-22, further comprising: receiving, via a third transmission of the HARQ procedure, the first set of information bits, the second set of information bits, and a third set of information bits, wherein the first set of information bits, the second set of information bits, and the third set of information bits are jointly encoded into a third polar codeword of a third size.
Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-23.
Aspect 25: An apparatus for wireless communication at a device, the apparatus comprising one or more memories and one or more processors coupled to the one or more memories, the one or more processors configured to cause the device to perform the method of one or more of Aspects 1-23.
Aspect 26: An apparatus for wireless communication, the apparatus comprising at least one means for performing the method of one or more of Aspects 1-23.
Aspect 27: A non-transitory computer-readable medium storing code for wireless communication, the code comprising instructions executable by one or more processors to perform the method of one or more of Aspects 1-23.
Aspect 28: A non-transitory computer-readable medium storing a set of instructions for wireless communication, the set of instructions comprising one or more instructions that, when executed by one or more processors of a device, cause the device to perform the method of one or more of Aspects 1-23.
Aspect 29: A device for wireless communication, the device comprising a processing system that includes one or more processors and one or more memories coupled with the one or more processors, the processing system configured to cause the device to perform the method of one or more of Aspects 1-23.
Aspect 30: An apparatus for wireless communication at a device, the apparatus comprising one or more memories and one or more processors coupled to the one or more memories, the one or more processors individually or collectively configured to cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A wireless communication device for wireless communication, comprising:
one or more memories; and
one or more processors, coupled to the one or more memories, configured to cause the wireless communication device to:
transmit, via a first transmission of a hybrid automatic repeat request (HARQ) procedure, a first set of information bits, wherein the first set of information bits are encoded into a first polar codeword of a first size; and
transmit, via a second transmission of the HARQ procedure, the first set of information bits and a second set of information bits, wherein the first set of information bits and the second set of information bits are jointly encoded into a second polar codeword of a second size.

2. The wireless communication device of claim 1, wherein the second set of information bits includes a set of new information bits and a set of copied information bits, wherein the set of copied information bits corresponds to a portion of the first set of information bits.

3. The wireless communication device of claim 2, wherein the set of copied information bits can be used as parity-check bits during a decoding process.

4. The wireless communication device of claim 1, wherein the one or more processors are further configured to:
utilize a polar code to generate a set of encrypted bits based at least in part on the second set of information bits; and
generate the second codeword based at least in part on performing an exclusive OR operation on the first polar codeword and the set of encoded bits.

5. The wireless communication device of claim 1, wherein the second set of information bits is included in the second transmission based at least in part on a quantity of bits included in the second set of information bits satisfying a condition.

6. The wireless communication device of claim 5, wherein the second set of information bits is not included in the second transmission when the quantity of bits included in the second set of information bits fails to satisfy the condition.

7. The wireless communication device of claim 5, wherein the quantity of bits included in the second set of information bits satisfies the condition based at least in part on the quantity of bits being less than or equal to a threshold.

8. The wireless communication device of claim 7, wherein the threshold is based at least in part on the first size and a quantity of bits included in the first set of information bits.

9. The wireless communication device of claim 1, wherein the one or more processors are further configured to cause the wireless communication device to:
generate a first set of cyclic redundancy check (CRC) bits based at least in part on the first set of information bits; and
generate a second set of CRC bits based at least in part on the second set of information bits.

10. The wireless communication device of claim 9, wherein the second set of CRC bits is included in the second transmission of the HARQ procedure.

11. The wireless communication device of claim 9, wherein the one or more processors, to cause the wireless communication device to generate the first set of CRC bits, are configured to cause the wireless communication device to:
generate the first set of CRC bits is generated separately from the second set of CRC bits.

12. The wireless communication device of claim 1, wherein the one or more processors are further configured to cause the wireless communication device to:
transmit, via a third transmission of the HARQ procedure, the first set of information bits, the second set of information bits, and a third set of information bits, wherein the first set of information bits, the second set of information bits, and the third set of information bits are jointly encoded into a third polar codeword of a third size.

13. A wireless communication device for wireless communication, comprising:
one or more memories; and
one or more processors, coupled to the one or more memories, configured to cause the wireless communication device to:
receive, via a first transmission of a hybrid automatic repeat request (HARQ) procedure, a first set of information bits, wherein the first set of information bits are encoded into a first polar codeword of a first size; and
receive, via a second transmission of the HARQ procedure, the first set of information bits and a second set of information bits, wherein the first set of information bits and the second set of information bits are jointly encoded into a second polar codeword of a second size.

14. The wireless communication device of claim 13, wherein the second set of information bits includes a set of new information bits and a set of copied information bits, wherein the set of copied information bits corresponds to a portion of the first set of information bits.

15. The wireless communication device of claim 14, wherein the one or more processors are further configured to cause the wireless communication device to:
use the set of copied information bits as parity-check bits during a decoding process.

16. The wireless communication device of claim 13, wherein the second set of information bits is included in the second transmission based at least in part on a quantity of bits included in the second set of information bits satisfying a condition.

17. The wireless communication device of claim 16, wherein the second set of information bits is not included in the second transmission when the quantity of bits included in the second set of information bits failing to satisfy the condition.

18. The wireless communication device of claim 16, wherein the quantity of bits included in the second set of information bits satisfies the condition based at least in part on the quantity of bits being less than or equal to a threshold.

19. The wireless communication device of claim 18, wherein the threshold is based at least in part on the first size and a quantity of bits included in the first set of information bits.

20. The wireless communication device of claim 13, wherein the first set of information bits is associated with a first set of cyclic redundancy check (CRC) bits that is generated based at least in part on the first set of information bits and the second set of information bits is associated with a second set of CRC bits that is generated based at least in part on the second set of information bits.

21. The wireless communication device of claim 20, wherein the second set of CRC bits is included in the second transmission of the HARQ procedure.

22. The wireless communication device of claim 20, wherein the first set of CRC bits is generated separately from the second set of CRC bits.

23. The wireless communication device of claim 13, wherein the one or more processors are further configured to cause the wireless communication device to:
receive, via a third transmission of the HARQ procedure, the first set of information bits, the second set of information bits, and a third set of information bits, wherein the first set of information bits, the second set of information bits, and the third set of information bits are jointly encoded into a third polar codeword of a third size.

24. A method of wireless communication performed by a wireless communication device, comprising:
transmitting, via a first transmission of a hybrid automatic repeat request (HARQ) procedure, a first set of information bits, wherein the first set of information bits are encoded into a first polar codeword of a first size; and
transmitting, via a second transmission of the HARQ procedure, the first set of information bits and a second set of information bits, wherein the first set of information bits and the second set of information bits are jointly encoded into a second polar codeword of a second size.

25. The method of claim 24, wherein the second set of information bits includes a set of new information bits and a set of copied information bits, wherein the set of copied information bits corresponds to a portion of the first set of information bits.

26. The method of claim 25, wherein the set of copied information bits can be used as parity-check bits during a decoding process.

27. The method of claim 24, wherein the second set of information bits is included in the second transmission based at least in part on a quantity of bits included in the second set of information bits satisfying a condition.

28. The method of claim 27, wherein the second set of information bits is not included in the second transmission when the quantity of bits included in the second set of information bits fails to satisfy the condition.

29. The method of claim 27, wherein the quantity of bits included in the second set of information bits satisfies the condition based at least in part on the quantity of bits being less than or equal to a threshold.

30. A method of wireless communication performed by a wireless communication device, comprising:
receiving, via a first transmission of a hybrid automatic repeat request (HARQ) procedure, a first set of information bits, wherein the first set of information bits are encoded into a first polar codeword of a first size; and
receiving, via a second transmission of the HARQ procedure, the first set of information bits and a second set of information bits, wherein the first set of information bits and the second set of information bits are jointly encoded into a second polar codeword of a second size.
